(19) United States
(12) Patent Application Publication
(10) Pub. No.: US 2011/0146881 A1
(43) Pub. Date: Jun. 23, 2011

(54) METHOD OF PRODUCING IMAGE DISPLAY APPARATUS

(75) Inventor: Naoki Furutani, Hadano-shi (JP)

(73) Assignee: CANON KABUSHIKI KAISHA, Tokyo (JP)

(21) Appl. No.: 12/970,479

(22) Filed: Dec. 16, 2010

(30) Foreign Application Priority Data
Dec. 21, 2009 (JP) 2009-289730

(51) Int. Cl. H01J 9/227

(52) U.S. Cl. 156/67

(57) ABSTRACT

Provided is a method of producing an image display apparatus where the probability of occurrence of breakage of spacers is significantly reduced. The method includes the step of forming an abutting layer containing a metal or a metal oxide and having a porosity ranging from 20% to 50% on a back plate or a front plate at positions where the spacers are abutted and the step of abutting the spacers on the abutting layer.

### BACKGROUND OF THE INVENTION

1. Field of the Invention

The present invention relates to a method of producing an image display apparatus having spacers between a front plate and a back plate.

2. Description of the Related Art

In a flat panel display, in order to achieve a uniform load on a spacer having uneven height disposed on a substrate, Japanese Patent Laid-Open No. 10-83778 discloses a technology of disposing a metal flexible member between the spacer and the substrate.

In the technology, the metal flexible member is made of gold or a gold-palladium alloy. Recently, a demand for a novel flexible member that can achieve a further uniform load on the spacer has been increasing, because that breakage of the spacer or breakage of the substrate on which the spacer is abutted, which is caused by the load, has not been sufficiently solved yet.

### SUMMARY OF THE INVENTION

The present invention provides a method of producing an image display apparatus having a back plate, a front plate disposed so as to face the back plate, spacers disposed between the back plate and the front plate, a frame member joining the back plate and the front plate and forming an airtight space between the back plate and the front plate, and image display members arranged in the airtight space. The method includes the step of forming an abutting layer containing a metal or a metal oxide and having a porosity ranging from 20% to 50% on the back plate or the front plate at positions where the spacers are abutted and the step of abutting the spacers on the abutting layer.

Further features of the present invention will become apparent from the following description of exemplary embodiments with reference to the attached drawings.

### BRIEF DESCRIPTION OF THE DRAWINGS

FIGS. 1A and 1B are schematic diagrams of an image display apparatus produced by a method according to an embodiment of the present invention.

FIGS. 2A and 2B are schematic diagrams of a front plate according to an embodiment of the present invention.

FIGS. 3A to 3C are schematic diagrams illustrating a method of forming an abutting layer according to an embodiment of the present invention.

FIG. 4A is a graph showing a relationship between resin particle content and porosity in the spacer-abutting layer.

FIG. 4B is a graph showing a relationship between deformation amount and porosity in the spacer-abutting layer.

FIGS. 5A and 5B are diagrams illustrating a method of measuring the relationship between deformation amount and porosity in the abutting layer.

FIGS. 6A and 6B are schematic diagrams of a back plate according to an embodiment of the present invention.

FIGS. 7A and 7B are schematic diagrams illustrating a method of abutting the spacers on the abutting layer according to an embodiment of the present invention.

### DESCRIPTION OF THE EMBODIMENTS

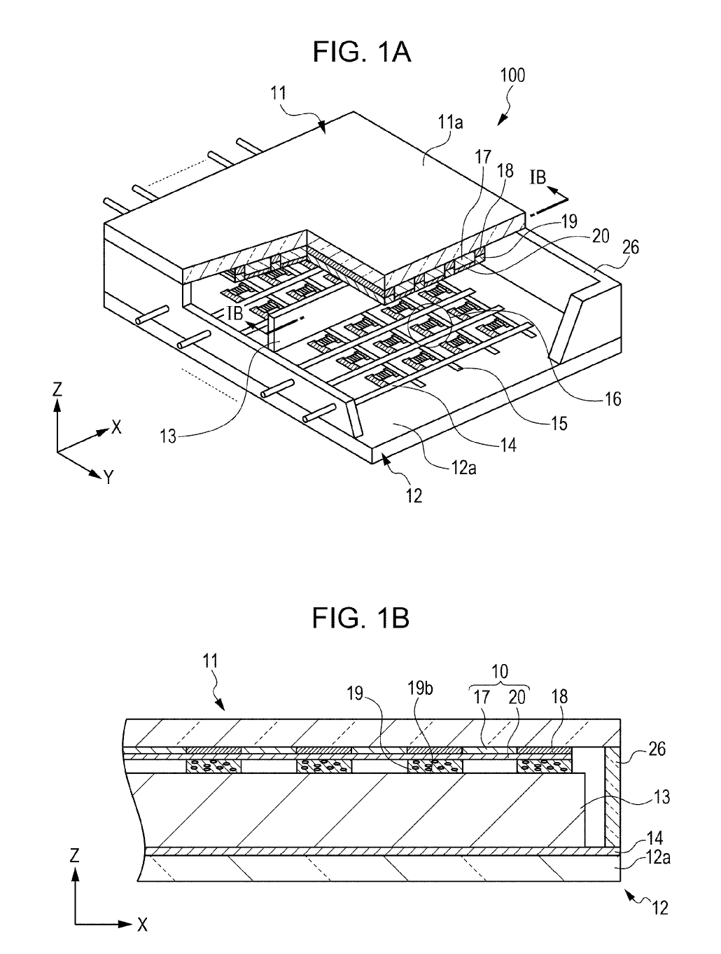

FIG. 1A is a partially cutaway perspective view of an image display apparatus 100 produced by a method according to an embodiment of the present invention, and FIG. 1B is a partially enlarged view of a cross-section taken along the line IB-IB of FIG. 1A. In the drawings of the present application, same reference numbers are used to the same member.

As shown in FIG. 1A, the image display apparatus according to the embodiment has a back plate 12, a front plate 11 disposed so as to face the back plate 12, and spacers 13 disposed between the back plate 12 and the front plate 11 and also includes a frame member 26 joining the back plate 12 and the front plate 11 and forming an airtight space between the back plate 12 and the front plate 11 and image display members arranged in the airtight space. In the embodiment, the image display members are arranged on a substrate 12a of the back plate 12 and on a substrate 11a of the front plate 11. The image display members arranged on the substrate 12a are a plurality of row wirings 14, a plurality of column wirings 15, and an electron source having a plurality of electron-emitting devices 16 matrix-wired to both the row and column wirings 14 and 15. The image display members 10 arranged on the substrate 11a are a plurality of light-emitting layers 17 and an anode electrode. In the embodiment showing a most preferred embodiment, the anode electrode also has a function of reflecting light as a light-reflecting layer 20 and is disposed on the light-emitting layers 17, and a light-shielding layer 18 is disposed among the plurality of light-emitting layers 17. FIG. 1B shows a state that the spacer 13 is abutted on an abutting layer 19 described below. In the embodiment, as shown in FIG. 1B, the abutting layer 19 having voids 19b is disposed on the light-shielding layer 18 disposed among the plurality of the light-emitting layers 17.

A method of producing the image display apparatus according to the embodiment will be described below.

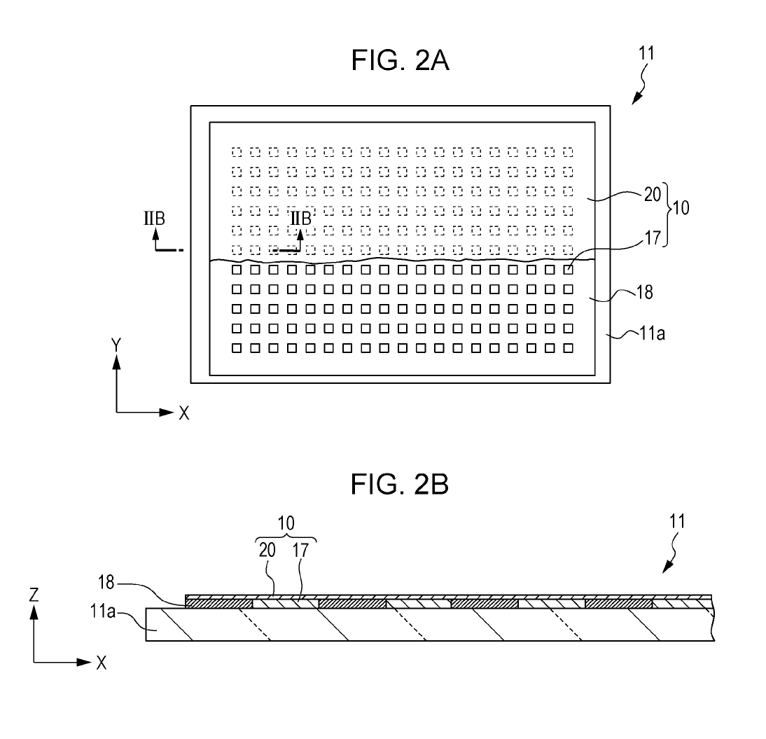

First, in the embodiment, a front plate 11 shown in FIGS. 2A and 2B is prepared.

FIG. 2A is a partially cutaway plan view of the front plate according to the embodiment, and FIG. 2B is an enlarged cross-sectional view taken along the line IIB-IIB of FIG. 2A.

As shown in FIGS. 2A and 2B, a light-shielding layer 18 having a plurality of openings arranged in a matrix form is formed on the substrate 11a of the front plate 11. The light-emitting layers 17 are formed in the openings of the light-shielding layer 18. Furthermore, a light-reflecting layer 20 covering the light-shielding layer 18 and the light-emitting layers 17 is formed. Note that the image display members 10 comprise the light-emitting layers 17 and the light-reflecting layer 20.

The substrate 11a transmits at least light having the wavelength of light emitted by the light-emitting layers 17. For example, the substrate 11a transmits light having a wavelength ranging from 360 to 830 nm, that is, visible light. The substrate 11a is typically a glass substrate such as a silica glass or soda-lime glass substrate.

The light-shielding layer 18 having a plurality of openings arranged in a matrix form is formed on the substrate 11a by, for example, applying a photo paste containing a black inorganic pigment onto the entire surface of the substrate 11a, exposing and developing the photo paste using a photo mask having a pattern corresponding to the openings, and then firing the photo paste. The photo paste can be applied onto the substrate 11a by, for example, screen printing or slit coating.

The light-emitting layers 17 are formed in the plurality of the openings arranged in a matrix form of the light-shielding layer 18 by, for example, applying a photo paste containing phosphor powder onto the light-shielding layer 18 and into the openings, exposing and developing the photo paste using a photo mask, and then firing the photo paste remaining in the openings of the light-shielding layer 18. The application of the photo paste onto the light-shielding layer 18 and into the openings can be conducted by, for example, screen printing.

The light-reflecting layer 20 is formed on the light-shielding layer 18 and on the light-emitting layers 17 by forming a resin layer on the light-shielding layer 18 and the light-emitting layers 17, forming a metal layer on the resin layer by, for example, vapor deposition or sputtering, and then firing the resin layer. The light-reflecting layer 20 can be made of a material having metallic luster, such as aluminum, and can have a thickness in a range of from 10 nm to 1 μm.

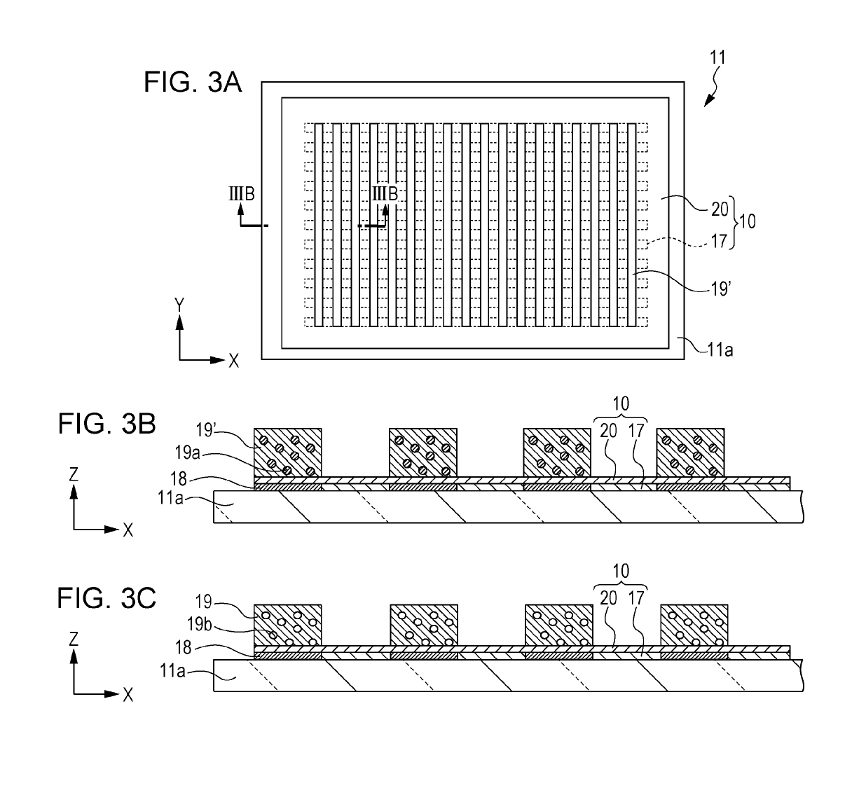

Then, as shown in FIGS. 3A and 3B, a precursor 19′ of the abutting layer is formed on the front plate 11. FIG. 3A is a plan view of the front plate provided with the precursor 19′ of the abutting layer of the embodiment, and FIG. 3B is an enlarged cross-sectional view taken along the line IIIB-IIIB of FIG. 3A. The precursor 19′ of the abutting layer is not necessary to be continuously formed into a stripe-like pattern shown in FIG. 3A, as long as it is formed on the front plate 11 at positions where the spacers are abutted, as described below. The precursor 19′ may be discontinuously formed on the front plate 11 at positions where the spacers are abutted. Note that the image display members 10 comprise the light-emitting layers 17 and the light-reflecting layer 20.

In the embodiment, as shown in FIG. 3B, the precursor 19′ of the abutting layer is formed on the light-shielding layer 18 among the plurality of light-emitting layers 17 constituting an image display member. The precursor 19′ of the abutting layer contains at least an inorganic solid, a binder for uniformly dispersing the inorganic solid, and resin particles 19a.

The inorganic solid is a plurality of metal particles or a plurality of metal oxide particles, and the precursor 19′ can further contain a frit in addition to the metal particles or the metal oxide particles. Since the frit functions as an adhesive material of the metal particles or the metal oxide particles, generation of debris from the abutting layer when the spacers are abutted on the abutting layer is reduced. Examples of the metal particles or the metal oxide particles being the inorganic solid include zinc oxide particles, titanium oxide particles, silver particles, gold particles, and aluminum particles, and these types of particles may be used alone or in combination. The metal particles or the metal oxide particles may be powder like and have a median diameter ranging from 10 to 100 nm. The frit as an inorganic solid may be any so-called glassy powder. For example, a lead-glass frit or a bismuth-glass frit can be used.

The binder may be any material that can disperse the inorganic solid, and examples thereof include acrylic resins, melamine resins, urea resins, acryl-melamine copolymer resins, melamine-urea copolymer resins, polyurethane resins, polyester resins, epoxy resins, alkyd resins, polyamide resins, vinyl resins, and cellulose resins. These materials can be used alone or in combination.

The resin particles 19a can be obtained by pulverizing a resin mass. However, resin particles having a uniform shape are preferred to those having different shapes, and approximately spherical resin particles (hereinafter, referred to as resin spheres) can be used. The resin spheres can be formed by a known method, for example, by suspension polymerization. Thermoplastic resin spheres may be produced by spraying a thermoplastic resin in a melted state and granulating the resin by cooling. The raw material of the resin particles 19a may be an alkyl acrylate resin having a linear-chain structure or an olefin resin having a linear-chain structure, and examples thereof include polybutylmethacrylate, polymethylmethacrylate, polymethylmethacrylate, polyethylene, and polystyrene. Furthermore, the commercially available resin spheres can be used. For example, as butyl methacrylate-based acrylic resin spheres, FA series (trade name, products of Fuji Shikiso Co., Ltd.) and BMX series (trade name, products of Sekisui Plastics Co., Ltd.) can be used. As methyl methacrylate-based acrylic resin spheres, MBX series (trade name, products of Sekisui Plastics Co., Ltd.), Liosphere (trade name, a product of Toyo Ink Mfg. Co., Ltd.), and Epostar MA series (trade name, products of Nippon Shokubai Co., Ltd.) can be used. As formaldehyde-condensed resin spheres, Epostar series (trade name, products of Nippon Shokubai Co., Ltd.) can be used. As polyethylene resin spheres, LE series (trade name, products of Sumitomo Seika Chemicals Company) can be used. These resins can be used alone or in combination as the resin particles 19a. The resin particles 19a having a particle diameter larger than that of the metal particles or metal oxide particles can easily provide a predetermined porosity described below to the abutting layer. For example, the resin particles 19a have a median diameter ranging from 0.5 to 5.0 μm.

The abutting layer can be easily provided with a predetermined porosity described below when the final temperatures of thermal decomposition of the binder and the resin particles 19a are lower than the melting point of the metal particles or the metal oxide particles contained as the inorganic solid. The final temperature of thermal decomposition is defined as follows: The temperature at which the mass loss in thermogravimetric analysis of the binder or the resin particles reaches 70% is called “standard temperature”. More specifically, the standard temperature is the temperature at which the mass loss reaches 70%, when a material having a predetermined mass is heated in air at a temperature-increasing rate of 10±1° C./min. That is, the standard temperature is the temperature at which the mass of the remaining material is 30% of the initial mass of the material. When a material is heated, the temperature at which mass loss starts is called initial temperature of thermal decomposition, the temperature at which the mass loss reaches 50% is called midpoint temperature of thermal decomposition, and the temperature at which the mass loss is finished is called final temperature of thermal decomposition. The standard temperature and the midpoint temperature are determined by thermogravimetric analysis of each material of the binder and the resin particles. The initial temperature of thermal decomposition and the final temperature of thermal decomposition are determined from a mass loss curve drawn by the thermogravimetric analysis. The details of the thermogravimetric analysis can be referred to JIS K 7120-1987.

In the embodiment, the precursor 19′ of the abutting layer mentioned above is formed by applying a paste being a mixture of at least the inorganic solid, the binder, and the resin particles 19a on the light-shielding layer 18 among the plurality of light-emitting layers 17 on the front plate 11 shown in FIG. 2A by, for example, printing and then drying the paste. In order to control the viscosity of the paste to a level suitable for the printing, the paste optionally contains a solvent for the binder. The solvent can be water, an organic solvent, or a mixture thereof. Examples of the organic solvent include isopropyl alcohol, toluene, xylene, methyl ethyl ketone, terpineol, butyl carbitol, and butyl carbitol acetate. The solvent is selected so as to hardly dissolve the resin particles 19a contained in the paste. Furthermore, the paste may contain a dispersant for improving the dispersibility of the resin particles 19a in the paste. The paste applied on the front plate 11 is dried by heating to form the precursor 19′ of the abutting layer. That is, the solvent in the paste or the solvent and the dispersant in the paste are removed by heating. The solvent and the dispersant may remain in the precursor 19′ of the abutting layer or may not be dried by heating, as long as the fluidity of the precursor 19′ of the abutting layer is a level capable of maintaining a predetermined shape of the precursor 19′.

Then, as shown in FIG. 3C, an abutting layer 19 having voids 19b therein is formed by removing the resin particles 19a in the precursor 19′ by heating the precursor 19′ of the abutting layer shown in FIG. 3B. The heating temperature is preferably higher than the standard temperatures of the binder and the resin particles contained in the precursor 19′ of the abutting layer, as described above. The heating temperature is more preferably higher than the final temperatures of thermal decomposition of the binder and the resin particles. Thus, the abutting layer 19 containing a metal or a metal oxide and having a porosity ranging from 20% to 50% is formed on the front plate 11 at positions where the spacers are abutted.

The thickness of the abutting layer 19 can be suitably adjusted according to uneven height of the spacers to be abutted. The lower limit of the thickness is 130% or more of the maximum variation in height of the spacers for enhancing uniformizing the load on the spacers. The maximum variation is determined as follows: First, the heights at a plurality of points of one spacer are measured. This measurement is conducted for all spacers, and the maximum value and the minimum value of the heights are determined from the measurement results. A value obtained by subtracting the minimum value from the maximum value is the maximum variation. The height of a spacer is the thickness of the spacer in the direction perpendicular to the back plate or the front plate on which the spacer is abutted. The upper limit of the thickness of the abutting layer 19 is preferably 20 μm or less and more preferably 17 μm, by considering the possibility of partial breakage of the abutting layer due to compression stress when the spacers are abutted. Based on such a thickness of the abutting layer 19, in the spacers applied to the embodiment, the maximum variation in height is 15.4 μm (=20 μm/130×100) or less, particularly preferably 13.1 μm (=17 μm/130×100) or less. The thickness of the abutting layer 19 is defined as an arithmetic average roughness Ra of the surface of a base on which the abutting layer 19 is formed, that is, in the embodiment, the distance from the central line determining the arithmetic average roughness Ra of the surface of a light-reflecting layer 18 to the central line determining the arithmetic average roughness Ra of the surface of the abutting layer.

The porosity of the abutting layer 19 in the embodiment ranges 20% to 50%. Its technical meaning will be described below.

The present inventors have conducted the following experiments. First, a paste having a composition shown in Table 1 was prepared. Then, resin particles were added to the paste in an amount of 0, 10, 20, 30, or 40 wt % relative to the amount of the inorganic solid.

TABLE 1

| | | |
|---|---|---|
| Inorganic solid | zinc oxide particles (median diameter: | 22 wt % |
| | 30 nm) | |
| | Bi glass frit | 5 wt % |
| Binder | ethyl cellulose | 4 wt % |
| Solvent | butyl carbitol acetate/α-terpineol-6 1 | 58 wt % |
| Resin particles | Fuji Shikiso Co., Ltd., trade name: FA-2.0S | 7 wt % |
| | (median diameter: 2 μm) | |
| Dispersant | Fuji Shikiso Co., Ltd., trade name: dsp-2 | 4 wt % |

The five pastes were applied on glass substrates by printing, dried at 110° C., and fired at 500° C. to form five types of abutting layers each having a thickness of 14 μm, a length of 60 μm, and a width of 60 μm on the glass substrates.

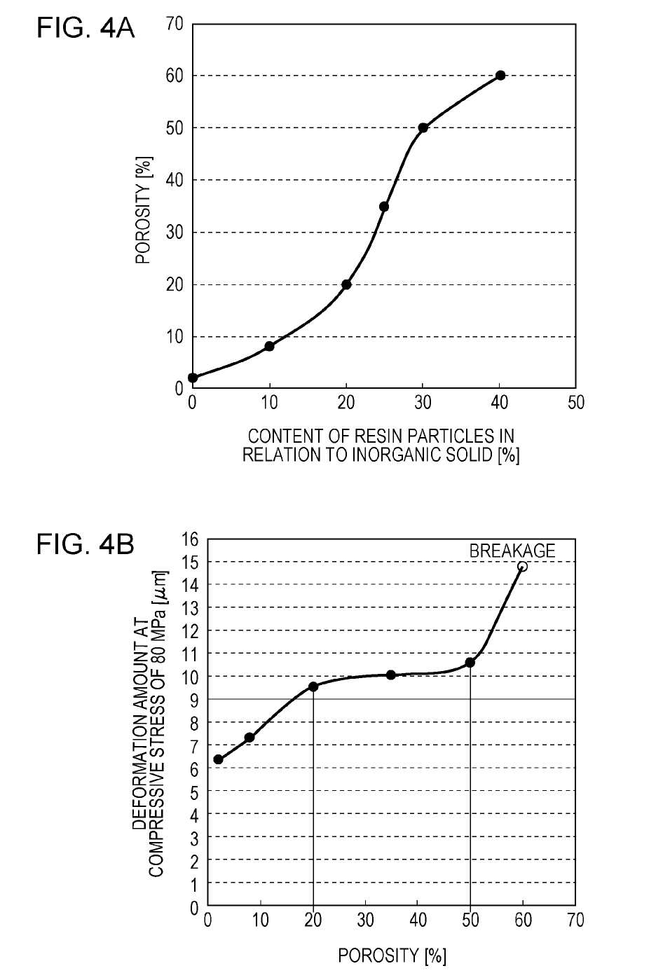

The volume ratio of voids (hereinafter, referred to as porosity) of each abutting layer was evaluated. The porosity was determined as an area ratio of voids to solid layer determined by binarized image analysis of a cross-sectional SEM image of the abutting layer. The results are shown in FIG. 4A. The results reveal that the porosity of voids formed in the abutting layer can be controlled by changing the amount of resin particles relative to the amount of the inorganic solid in the paste for forming the abutting layer.

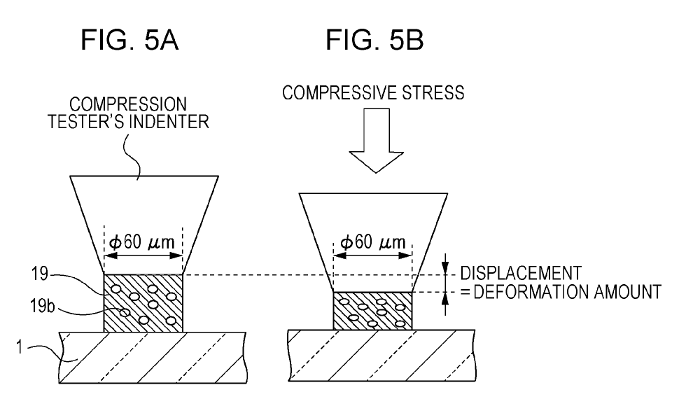

Furthermore, the present inventors have investigated a relationship between the amount of the deformation of the abutting layer and the porosity. The method for the evaluation is shown in FIGS. 5A and 5B. An indenter with a bottom size of Φ 60 μm is pressed upon an abutting layer 19 formed on a glass substrate 1, and the amount of displacement of the indenter after application of a compressive stress of 80 MPa (FIG. 5B) from the state (FIG. 5A) before the application of the compressive stress was measured as the amount of deformation. A micro compression testing machine MCT-W500-J, a product of Shimadzu Corporation, was used as the compression tester. The results are shown in FIG. 4B. The results reveal that when the porosity is 60%, yield fracture partially occurs in the abutting layer and that the porosity should be 50% or less. Furthermore, from FIG. 4B, it is revealed that when the porosity is 20% or less, the change in the amount of deformation is large relative to the porosity. In this range, a relatively large variation in the amount of deformation occurs when the amount of the resin particles contained in the paste varies.

In order to ensure a predetermined amount of deformation at the entire positions where the spacers are abutted in an image display apparatus, it is desirable to control the porosity to a range where the change in the amount of deformation is small. It was revealed that the change in the amount of deformation is small when the porosity of the abutting layer is controlled to a range of 20% to 50% and that the amount of deformation in this range is 9 μm or more.

The experimental results above show that the porosity in the abutting layer can be controlled to the range of 20% to 50% by controlling the amount of the resin particles in a range of 20 to 30 wt % relative to the amount of the inorganic solid in the paste for forming the abutting layer or in the precursor of the abutting layer.

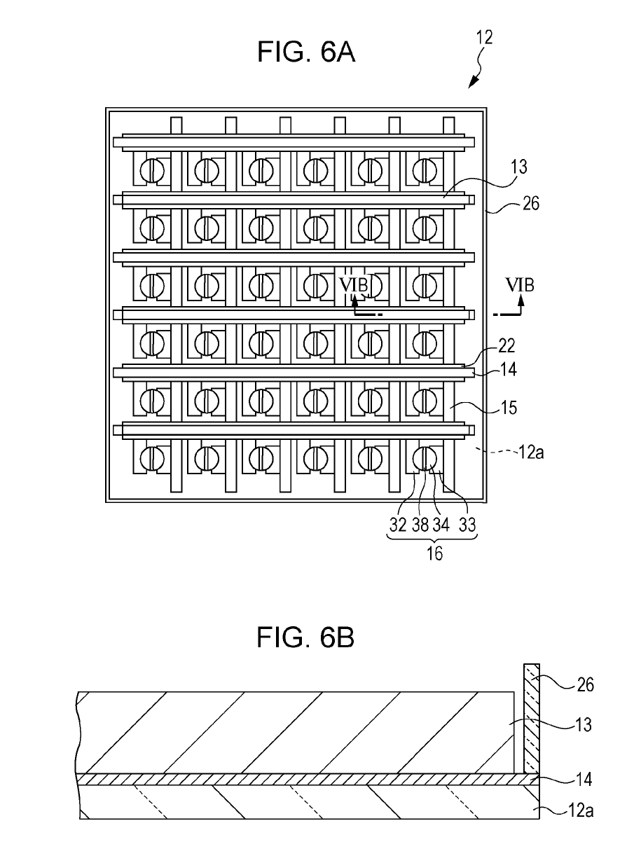

Then, a back plate 12 shown in FIGS. 6A and 6B is prepared.

FIG. 6A is a plan view of the back plate of the embodiment, and FIG. 6B is an enlarged cross-sectional view taken along the line VIB-VIB of FIG. 6A.

As shown in FIGS. 6A and 6B, on the substrate 12a of the back plate 12, a matrix source where a plurality of electron-emitting devices 16 arranged in a matrix form are matrix-wired to a plurality of row wirings 14 and column wirings 15 is formed. The substrate 12a may be a glass substrate such as a silica glass or soda-lime glass substrate. The electron-emitting device 16 is a surface-conduction electron-emitting device including a pair of electrodes 32 and 33 disposed with a space therebetween and an electrically conductive film 34 having an electron-emitting portion 38 connected to the pair of electrodes 32 and 33. The electron-emitting device 16 can be formed by a widely known method. In the embodiment, the surface-conduction electron-emitting device was mentioned as an example, but the electron-emitting device 16 is not limited thereto. The plurality of row wirings 14 and the plurality of column wirings 15 can be formed by, for example, screen printing using a paste containing silver as a main component. In FIG. 6A, insulating layers 22 for insulating between the row wirings 14 and the column wirings 15 are shown. The insulating layers 22 can be formed by, for example, screen printing using a paste containing SiO₂ as a main component.

Furthermore, a plurality of spacers 13 are fixed on the row wirings 14 on the back plate 12 in advance. The spacer 13 is fixed by bonding its both ends in the longitudinal direction to the row wiring 14 or to the back plate 12 with an adhesive. The spacer 13 can be made of glass or ceramics. Furthermore, the surface of the spacer 13 may be covered by a resistance film for preventing electrostatic charging. As the adhesive, for example, a glass frit or a reactive inorganic adhesive is used. Furthermore, a frame member 26 is fixed on the back plate 12. The frame member shown in FIG. 6A is partially cut away for convenience of illustration, but since the frame member 26 joins the back plate 12 and the front plate 11 and forms an airtight space between the back plate 12 and the front plate 11, it is disposed on the periphery of the back plate 12. The back plate 12 and the frame member 26 can be fixed with frit glass or a metal.

Then, the spacers 13 are abutted on the abutting layer.

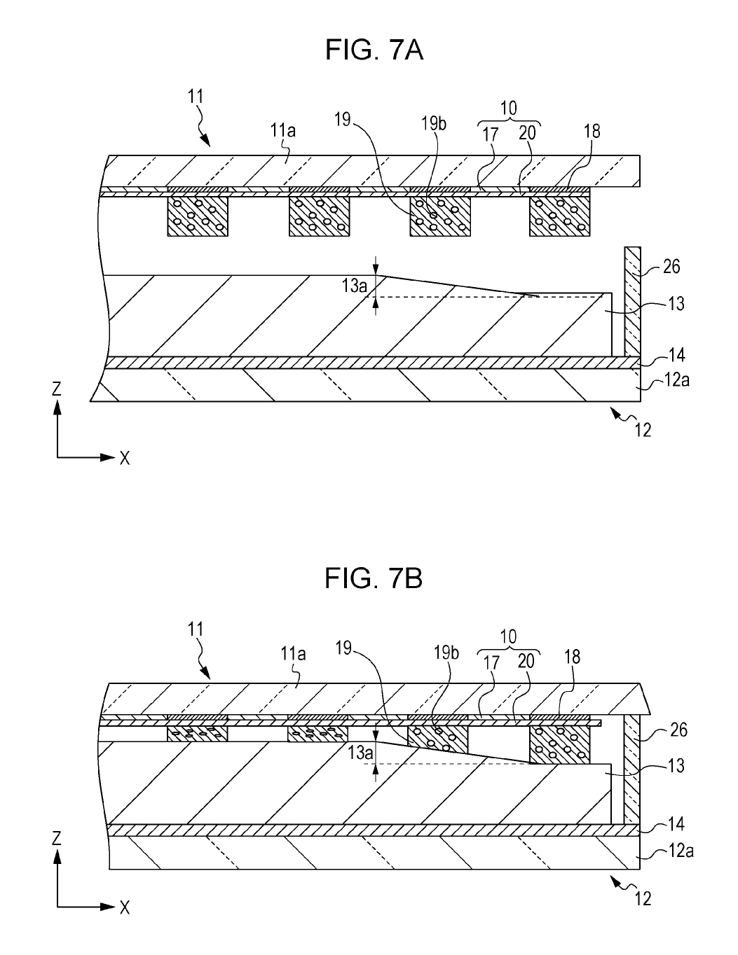

First, an adhesive is applied to the frame member 26 on the back plate 12 shown in FIG. 6B. The adhesive may be frit glass or a metal. Then, the back plate 12 is placed such that the surface of the frame member 26 applied with the adhesive faces upward, and, as shown in FIG. 7A, the back plate 12 and the front plate 11 shown in FIG. 3C are arranged with a tool (not shown) so that the abutting layer 19 and the spacers 13 face each other. In the embodiment, as shown in FIG. 7A, one spacer 13 has a maximum variation 13a in height at one end in the longitudinal direction. Then, the back plate 12 and the front plate 11 disposed so as to face each other are placed in a vacuum chamber. The image display members 10 comprise the light-emitting layers 17 and the light-reflecting layer 20.

Then, the inside of the vacuum chamber is deaerated, and the adhesive on the frame member 26 is heated. When the pressure in the vacuum chamber has reached to about 1.3×10⁻³ to 1.3×10⁻⁵ Pa, the spacers 13 are abutted on the abutting layer 19 by pressing the front plate 11 onto the frame member 26 on the back plate 12. The back plate 12 and the front plate 11 are joined through the frame member 26 by returning the inside of the vacuum chamber to ordinary temperature and ordinary pressure to form a depressurized airtight space between the back plate 12 and the front plate 11.

In the embodiment, the spacers 13 are abutted on the abutting layer 19 in a vacuum chamber, but the spacers 13 may be abutted on the abutting layer 19 under atmospheric pressure. In such a case, after the spacers 13 are abutted on the abutting layer 19, the back plate 12 and the front plate 11 are joined through the frame member 26, and a depressurized airtight space is formed between the back plate 12 and the front plate by exhausting from an exhaust pipe provided to the substrate 11a of the front plate 11 or the substrate 12a of the back plate 12.

As shown in FIG. 7B, since the abutting layer 19 of the thus-produced image display apparatus has suitable voids 19b, the variation in the height of the spacers 13 is absorbed, and the load on the spacers 13 is further uniformized. Therefore, a method capable of producing an image display apparatus where the probability of occurrence of breakage of the spacers 13 is significantly reduced can be provided. The image display members 10 comprise the light-emitting layers 17 and the light-reflecting layer 20.

In the embodiment described above, the abutting layer is disposed on the front plate, but a configuration where the abutting layer is disposed on the back plate also can achieve similar effects. When the abutting layer is disposed on the back plate, the spacers are fixed to the front plate at regions excluding the light-emitting layers, and the abutting layer is formed on the back plate at regions excluding the electron-emitting devices. For example, the spacers are fixed to the light-shielding layer 18 excluding the light-emitting layers 17 shown in FIGS. 2A and 2B, and the abutting layer is formed on the row wirings 14, instead of the spacers 13 shown in FIGS. 6A and 6B.

In addition, in the embodiment, the spacers are a plate-like member as shown in FIGS. 1, 6, and 7, but application of the embodiment is not limited thereto. In image display apparatuses such as electron-beam displays, in order to reduce halation, partitions called ribs are disposed among light-emitting layers of the front plate in some cases. The partition is one type of the spacers for maintaining the distance between the front plate and the back plate described in the embodiment. Partitions called ribs for maintaining a distance between the front plate and the back plate in image display apparatuses such as plasma displays are also one type of the spacers described in the embodiment. An effect similar to that in the embodiment can be obtained against variations in heights of these partitions by applying abutting layers having a predetermined porosity as described in the embodiment. Furthermore, a plurality of structures that are stacked between the front plate and the back plate and maintain the distance between the front plate and the back plate are each one of the spacers described in the embodiment. When a plurality of structures is stacked to maintain the distance between the front plate and the back plate, an effect similar to that of the embodiment can be obtained by actually measuring variation in height for each structure and applying the embodiment to the structure showing a largest maximum variation in height.

### EXAMPLES

### Example 1

First, the front plate 11 shown in FIGS. 3A and 3B was prepared. The substrate 11a was a glass substrate (length: 600 mm, width: 1000 mm, thickness: 1.8 mm) called PD200. The light-shielding layer 18 formed on the substrate 11a was a black member having a thickness of 5 μm and openings with a pitch of 450 μm in the Y direction and a pitch of 150 μm in the X direction. The size of the opening was 220 μm in the Y direction and 90 μm in the X direction. The light-emitting layers 17 positioned at the openings of the light-shielding layer 18 were made of P22 phosphor, which is widely used in the CRT field, and had a thickness of 15 μm. The light-reflecting layer 20 covering the light-shielding layer 18 and the light-emitting layers 17 was formed of an aluminum film having a thickness of 100 nm.

Then, spacers were prepared, and the maximum variation in height of the spacers was determined. The spacer was a plate-like spacer 13 shown in FIGS. 1A and 1B and was made of glass, called PD200. Twenty spacers having a width of 60 μm, a height of 1.5 mm, and a length of 954 mm were prepared. Each of the twenty spacers 13 was measured for the height at 20 points equally spaced in the longitudinal direction, and measured values of 400 points (20 points×20 spacers) were obtained. From the 400 measured values, maximum variation was determined to be 9 μm ((maximum value)−(minimum value)=9 μm).

Then, as shown in FIGS. 3A and 3B, a precursor 19′ of the abutting layer was formed on the prepared front plate 11. A paste having a composition shown in Table 2 was prepared so that the abutting layer 19 shown in FIG. 3C has a thickness of 14 μm and a porosity of 20%. This paste was printed among the light-emitting layers 17 of the front plate 11 in a stripe shape having a width of 60 μm and then dried at 110° C. to form the precursor 19′ of the abutting layer on the front plate 11, as shown in FIGS. 3A and 3B.

In the paste for forming the abutting layer in this Example, zinc oxide particles having a median diameter of 30 nm were used as the metal oxide, and butyl methacrylate-based acrylic resin spheres having a median diameter of 2 μm were used as the resin particles 19a. The butyl methacrylate-based acrylic resin spheres had an initial temperature of thermal decomposition of 250° C., a final temperature of thermal decomposition of 400° C., and a standard temperature of 330° C.

The median diameters of the metal oxide particles and the resin particles 19a were each measured in advance in their powder form before the preparation of the paste for forming the abutting layer. In the metal oxide particles or the resin particles 19a having a median diameter of 6 μm or less, the median diameters were determined by a dynamic light scattering method using Zetasizer Nano ZS (trade name, a product of Sysmex Corporation). In the metal oxide particles or the resin particles 19a having a median diameter larger than 6 μm, the median diameters were determined by a laser diffraction scattering method using Mastersizer 2000 (trade name, a product of Sysmex Corporation). The laser diffraction scattering method can be also applied to measurement of median diameters not larger than 6 μm. Note that no significant differences were observed as a whole in the shapes of the particles in the powder forms and in cut surfaces after application as a paste and drying of the metal oxide particles and the resin particles, when observed with an electron microscope. The sizes of the metal oxide particles and the resin particles observed with an electron microscope seemed to be near their median diameters.

TABLE 2

| | | |
|---|---|---|
| Inorganic solid | zinc oxide particles (median diameter: | 23.1 wt % |
| | 30 nm) | |
| | Bi glass frit | 5.2 wt % |
| Binder | ethyl cellulose | 4.0 wt % |
| Solvent | butyl carbitol acetate/α-terpineol-6 1 | 58.0 wt % |
| Resin particles | Fuji Shikiso Co., Ltd., trade name: | 5.7 wt % |
| | FA-2.0S (median diameter: 2 μm) | |
| Dispersant | Fuji Shikiso Co., Ltd., trade name: dsp-2 | 4.0 wt % |

Then, the precursor 19′ of the abutting layer shown in FIGS. 3A and 3B was fired at 500° C. to form the abutting layer 19 having a thickness of 14 μm shown in FIG. 3C.

Another front plate formed by the same method for testing was subjected to electron microscopic observation for a cut surface of the abutting layer 19 to confirm that the resin particles 19a were burned down to form voids 19b in the abutting layer 19. Furthermore, the porosity was estimated to be 20% from binarized image analysis of a cross-sectional FIB-SEM image. The front plate for testing was subjected to measurement of the amount of deformation in the abutting layer 19 at 100 points on the surface of the front plate 11 using an indenter with a bottom size of Φ 60 μm of a micro compression testing machine MCT-W500-J, a product of Shimadzu Corporation. The results were that the amount of deformation of the abutting layer 19 at a compression stress of 80 MPa was 9.5±0.5 μm.

Then, as shown in FIGS. 6A and 6B, the back plate 12 was prepared, and the spacers 13 and the frame member 26 were arranged on the back plate 12.

The substrate 12a was a glass substrate (length: 600 mm, width: 1000 mm, thickness: 1.8 mm) called PD200. On the substrate 12a, a plurality of row wirings 14 and a plurality of column wirings 15 were formed using an Ag paste by screen printing. The electron-emitting devices 16 were surface-conduction electron-emitting devices and were arranged with the same pitch as that of the openings provided to the light-shielding layer 18 of the front plate. The twenty spacers 13 were fixed on the row wirings 14 on the back plate 12 with approximately equal spaces therebetween. The spacer 13 was fixed by bonding its both ends to the row wiring 14 with a heat-resistant inorganic adhesive, “Aron Ceramics W”, a product of Toagosei Co., Ltd. Furthermore, the frame member 26 made of glass was fixed to the back plate 12 by bonding with a glass frit applied to the periphery of the substrate 12a.

Then, as shown in FIGS. 7A and 7B, the spacers 13 were abutted on the abutting layer 19.

First, the frit glass was applied onto the frame member 26 and was heated to 200° C. for calcining the frit glass. The back plate 12 and the front plate 11 were placed with a tool (not shown) so that the abutting layer 19 and the spacers 13 face each other. The positions of the light-emitting layers 17 of the front plate 11 and the electron-emitting devices 16 of the back plate 12 were adjusted, and the relative positions of both substrates were fixed in a state that a distance was provided between both substrates. Both substrates were placed between a pair of hot plates of a vacuum chamber. The pair of hot plates was provided with a hoisting and lowering mechanism. The inside of the vacuum chamber was deaerated to 1.3×10⁻⁵ Pa, and then the hot plates were brought into contact with both substrates and heated the substrates to 400° C. Then, the front plate 11 was pressed against the back plate 12 with the hoisting and lowering mechanism. After both substrates were cooled to ordinary temperature, the pressure in the vacuum chamber was increased to ordinary pressure, and the substrates were taken out.

Thus, the spacers 13 were abutted on the abutting layer 19 to form an image display apparatus.

The substrate 11a of the front plate 11 of the image display apparatus produced in this example was perforated to make the pressure in the airtight space surrounded by the front plate 11, the back plate 12, and the frame member 26 to an atmospheric pressure. Then, the front plate 11 was separated from the image display apparatus by cutting the bonding portion between the front plate 11 and the frame member 26.

The abutting layer 19 of the separated front plate 11 and the spacers 13 of the back plate 12 were observed with an optical microscope. First, the abutting surfaces of all spacers 13 with the abutting layer 19 were investigated to confirm no breakage and chipping occurred. In addition, no breakage was observed in the abutting layer 19. Furthermore, evidence of abutting with the spacers 13 was observed in the entire abutting region of the abutting layer 19.

In the separated front plate 11, the cut surfaces of the abutting layer 19 at the regions being positioned among the spacers 13 and on which the spacers 13 were not abutted were observed with an electron microscope. The porosity was estimated to be 20% from binarized image analysis of a cross-sectional FIB-SEM image of the abutting layer.

### Example 2

In this example, an image display apparatus was produced as in Example 1 except that the composition of the paste for forming the abutting layer was changed so that the abutting layer 19 had a thickness of 14 μm and a porosity of 50%. The composition of the paste used in this example is shown in Table 3.

TABLE 3

| | | |
|---|---|---|
| Inorganic solid | zinc oxide particles (median diameter: | 21.2 wt % |
| | 30 nm) | |
| | Bi glass frit | 4.8 wt % |
| Binder | ethyl cellulose | 4.0 wt % |
| Solvent | butyl carbitol acetate/α-terpineol-6 1 | 58.0 wt % |
| Resin particles | Fuji Shikiso Co., Ltd., trade name: | 8.0 wt % |
| | FA-2.0S (median diameter: 2 μm) | |
| Dispersant | Fuji Shikiso Co., Ltd., trade name: dsp-2 | 4.0 wt % |

As in Example 1, a cut surface of the abutting layer 19 of the front plate for testing was observed with an electron microscope to confirm that the resin particles 19a were burned down to form voids 19b in the abutting layer 19. The porosity was estimated to be 50% from binarized image analysis of a cross-sectional FIB-SEM image. Furthermore, the front plate for testing was subjected to measurement of the amount of deformation in the abutting layer 19 at 100 points on the surface of the front plate 11 using an indenter with a bottom size of Φ 60 μm of a micro compression testing machine MCT-W500-J, a product of Shimadzu Corporation. The results were that the amount of deformation of the abutting layer 19 at a compression stress of 80 MPa was 10±0.5 μm.

As in Example 1, the abutting layer 19 of the separated front plate 11 and the spacers 13 of the back plate 12 were observed with an optical microscope. First, the abutting surfaces of all spacers 13 with the abutting layer 19 were investigated to confirm no breakage and chipping occurred. In addition, no breakage was observed in the abutting layers 19. Furthermore, evidence of abutting with the spacers 13 was observed in the entire abutting region of the abutting layer 19.

In the separated front plate 11, the cut surfaces of the abutting layer 19 at the regions being positioned among the spacers 13 and on which the spacers 13 were not abutted were observed with an electron microscope. The porosity was estimated to be 50% from binarized image analysis of a cross-sectional FIB-SEM image of the abutting layer.

### Comparative Example 1

In this Comparative Example, an image display apparatus was produced as in Example 1 except that the composition of the paste for forming the abutting layer 19 did not contain resin particles of Example 1.

As in Example 1, a cut surface of the abutting layer of the front plate for testing was observed with an electron microscope to confirm that very few voids were formed in the abutting layer. The porosity was estimated to be 2% from binarized image analysis of a cross-sectional FIB-SEM image. Furthermore, the front plate for testing was subjected to measurement of the amount of deformation in the abutting layer at 100 points on the surface of the front plate using an indenter with a bottom size of Φ 60 μm of a micro compression testing machine MCT-W500-J, a product of Shimadzu Corporation. The results were that the amount of deformation of the abutting layer at a compression stress of 80 MPa was 6±0.5 μm.

As in Example 1, the abutting layer of the separated front plate and the spacers of the back plate were observed with an optical microscope. First, the abutting surfaces of all spacers with the abutting layer were investigated to confirm obvious chipping occurred at several positions. In addition, no evidence of abutting with the spacers was observed in some positions in the abutting region of the abutting layer.

### Examples 3 and 4

Image display apparatuses in Examples 3 and 4 were produced as in Examples 1 and 2, respectively, except that the resin particles contained in the pastes for forming the abutting layers were methyl methacrylate-based acrylic resin spheres having a median diameter of 2 μm.

The methyl methacrylate-based acrylic resin spheres had an initial temperature of thermal decomposition of 250° C., a final temperature of thermal decomposition of 410° C., and a standard temperature of 350° C.

Example 3 showed similar results to those in Example 1, and Example 4 showed similar results to those in Example 2.

### Examples 5 and 6

Image display apparatuses in Examples 5 and 6 were produced as in Examples 1 and 2, respectively, except that the resin particles contained in the pastes for forming the abutting layers were polyformaldehyde resin spheres having a median diameter of 2 μm.

The polyformaldehyde resin spheres had an initial temperature of thermal decomposition of 300° C., a final temperature of thermal decomposition of 400° C., and a standard temperature of 370° C.

Example 5 showed similar results to those in Example 1, and Example 6 showed similar results to those in Example 2.

### Examples 7 and 8

Image display apparatuses in Examples 7 and 8 were produced as in Examples 1 and 2, respectively, except that the pastes used for forming the abutting layers contained titanium oxide particles (median diameter: 30 nm) instead of the zinc oxide particles (median diameter: 30 nm).

Example 7 showed similar results to those in Example 1, and Example 8 showed similar results to those in Example 2.

### Examples 9 and 10

Image display apparatuses in Examples 9 and 10 were produced as in Examples 1 and 2, respectively, except that the pastes used for forming the abutting layers contained silver particles (median diameter: 30 nm) instead of the zinc oxide particles (median diameter: 30 nm).

Example 9 showed similar results to those in Example 1, and Example 10 showed similar results to those in Example 2.

### Examples 11 and 12

Image display apparatuses in Examples 11 and 12 were produced as in Examples 1 and 2, respectively, except that the pastes used for forming the abutting layers contained gold particles (median diameter: 30 nm) instead of the zinc oxide particles (median diameter: 30 nm).

Example 11 showed similar results to those in Example 1, and Example 12 showed similar results to those in Example 2.

### Examples 13 and 14

Image display apparatuses in Examples 13 and 14 were produced as in Examples 1 and 2, respectively, except that the pastes used for forming the abutting layers contained aluminum particles (median diameter: 30 nm) instead of the zinc oxide particles (median diameter: 30 nm).

Example 13 showed similar results to those in Example 1, and Example 14 showed similar results to those in Example 2.

### Examples 15 and 16

Image display apparatuses in Examples 15 and 16 were produced as in Examples 1 and 2, respectively, except that the pastes used for forming the abutting layers contained butyl methacrylate-based acrylic resin spheres having a median diameter of 0.5 μm instead of the resin particles.

The butyl methacrylate-based resin spheres had an initial temperature of thermal decomposition of 250° C., a final temperature of thermal decomposition of 400° C., and a standard temperature of 330° C.

Example 15 showed similar results to those in Example 1, and Example 16 showed similar results to those in Example 2.

### Examples 17 and 18

Image display apparatuses in Examples 17 and 18 were produced as in Examples 1 and 2, respectively, except that the pastes used for forming the abutting layers contained butyl methacrylate-based acrylic resin spheres having a median diameter of 5 μm instead of the resin particles.

Example 17 showed similar results to those in Example 1, and Example 18 showed similar results to those in Example 2.

### Examples 19 and 20

Image display apparatuses in Examples 19 and 20 were produced as in Examples 1 and 2, respectively, except that the pastes used for forming the abutting layers did not contain the Bi glass frit and the zinc oxide particles (median diameter: 30 nm) but did contain silver particles (median diameter: 30 nm) in an amount of the sum of the contents of the Bi glass frit and the zinc oxide particles in Examples 1 and 2.

Example 19 showed similar results to those in Example 1, and Example 20 showed similar results to those in Example 2.

The present invention can provide a method of producing an image display apparatus where the probability of occurrence of breakage of the spacers is significantly reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-289730 filed Dec. 21, 2009, which is hereby incorporated by reference herein in its entirety.

What is claimed is:

1. A method of producing an image display apparatus including a back plate, a front plate disposed so as to face the back plate, spacers disposed between the back plate and the front plate, a frame member joining the back plate and the front plate and forming an airtight space between the back plate and the front plate, and image display members arranged in the airtight space, the method comprising the steps of:
forming an abutting layer containing a metal or a metal oxide and having a porosity ranging from 20% to 50% on the back plate or the front plate at positions where the spacers are abutted; and
abutting the spacers on the abutting layer.

2. The method according to claim 1, wherein the step of forming an abutting layer comprises forming a precursor of the abutting layer including an inorganic solid containing a plurality of metal particles or a plurality of metal oxide particles and a plurality of resin particles on the back plate or the front plate at positions where the spacers are abutted and then heating the precursor of the abutting layer.

3. The method according to claim 2, wherein the amount of the plurality of resin particles in the precursor of the abutting layer ranges from 20 to 30 wt % relative to the amount of the inorganic solid.

4. The method according to claim 2, wherein the inorganic solid in the precursor of the abutting layer contains a frit.
